(19) United States
(12) Patent Application Publication
(10) Pub. No.: US 2005/0112535 A1
(43) Pub. Date: May 26, 2005

(54) Method for enabling conflict resolution

(76) Inventor: Helen B. McIntosh, Dalton, GA (US)

Correspondence Address: MILES & STOCKBRIDGE PC, 1751 PINNACLE DRIVE, SUITE 500, MCLEAN, VA, 22102-3833, US

(21) Appl. No.: 11/000,416

(22) Filed: Dec. 1, 2004

Related U.S. Application Data
(62) Division of application No. 09/661,447, filed on Sep. 13, 2000.

(51) Int. Cl. G09B 19/00

(52) U.S. Cl. 434/236

(57) ABSTRACT

System and method for enabling school age children, and others, in conflict or dispute, who lack the skills necessary to express their desires and emotions, either at all, or in a courteous, safe manner, to do so in an effective way, by providing a conflict resolution location adapted to receive a dedicated portable object, such as a small rug, to be used, together with a specialized, script and a set of simple procedural rules. The process is directed toward replacing confrontational circumstances with a neutral meeting ground, the “Peace Rug”, to which a degree of respect is accorded, and where specific rules of conduct apply. All concerned join in a face-to-face relationship, preferably sitting on, or in proximity, to the rug during the entire process and engage in a scripted conversation during which each participant exercises, and thereby develops, the ability to voice his or her concern and desires with respect to a perceived offensive action perpetrated by another child. The process concludes with the development of a mutually agreeable plan, and promotion of individual pride and responsibility for that accomplishment.

### BACKGROUND OF THE INVENTION

1. Field of the Invention

The present invention relates to resolution of interpersonal conflicts, and more particularly, to a system and method for achieving conflict resolution.

2. Description of Related Art

Violence in schools and other locations where interpersonal relationships are involved has become a critical national issue in the United States, as documented in a training participant manual titled “Respect and Protect: Violence Prevention and Intervention”, the Hazelden/Johnson Institute, 1999, based on a violence intervention and prevention model originally developed by Carole Remboldt and others. This manual describes violence and interpersonal conflicts in terms of a “Violence Continuum”. An example of the low end of the Violence Continuum is “the look” or eye-rolling. An example of the high end of this continuum is the shooting of a person with a gun. The behaviors on the Violence Continuum, especially at the higher end of the continuum, are considered to be “bully behaviors.” Trainer Roger Dinwiddie, a contributor to the aforementioned manual, found that reports indicate that school shootings have not been done by bullies, but instead, by victims of long-term bullying. The dynamics involved in conflict behavior are that victims of ongoing bullying 1) are unable to speak up and defend themselves; 2) suppress their emotions and feelings; and 3) eventually copycat the bully behaviors at the high end of the Violence Continuum and are the ones most likely to commit violence, as opposed to the “bully”.

It has been found that those who are victims of violence and conflicts, directly or indirectly, need to learn how to speak up and defend themselves, or remain at high risk for committing violence as a result of long periods of victimization. It is known that unless family patterns of violent behavior are broken and changed, those children who are victims of such behavior tend to repeat the same destructive patterns.

One method of dealing with the Violence Continuum, which is practiced at many schools, is called “peer mediation”, in which more mature students are trained to facilitate others who are in conflict. One drawback of this approach is dependency on a third party to resolve any difficulties. As a result, the children still not have found their own “voice”, i.e., their own ability to settle their differences and disputes and be self-assertive in a socially acceptable manner.

Other approaches to conflict resolution include programs intended to address family units, co-workers and older elementary students by teaching individual subjects, such as, for example, self-esteem and respect for others. Core curriculum elements can be established, such as good behavior, decision making, and refusal skills. In addition, a curriculum of anti-violence subjects such as conflict resolution, communication, anger management, and bully-victim interventions have been shown to be helpful to individuals in a variety of situations. In one case, special emphasis was given to helping children express their thoughts and feelings, which, in counseling terms, is called “finding one's voice.” Progress was made in the children's social, cognitive, and emotional development, but normal conflicts and bully-victim violence acted out at school continued to be present. The children learned each of these skills separately and effectively, but were unable to integrate all of them into a more consistent behavior. As a result, the goal of complete elimination of unresolved conflicts on the school campus could not be met.

In attempts to provide a focal point for conflict resolution discussion in the classroom and family environments, the readily available option of using a designated table or desk for face-to-face communication has been considered, but tables and desks lack sufficient uniqueness in terms of special identity with the conflict resolution process, which is an important element, particularly with children. Similarly shaped tables, such as round tables, have been considered, but given the many dozens of classrooms or room units potentially involved and the economic realities of room layouts in buildings, this option frequently proves to be unattractive. Moreover, in addition to lacking any special symbolic relationship with an important process, tables and desks in general lack portability, which prevented their use in areas away from the participant's immediate area of occupation. Further, desks and tables require participants to be set apart from each other and not in close, face-to-face contact.

Therefore, a primary object of the present invention is to provide a system and method for achieving actual integration of the interpersonal skills taught to individuals.

An additional object of the present invention is to provide a simple process so that small children and even the most sophisticated adults could understand.

Another object of the present invention is that a student involved in a conflict could be empowered to be able to do peacemaking on his or her own.

A further object of the present invention is to provide a definite, decisive “place” that is small, portable, and cost effective, where one or more persons could gather to share thoughts and feelings in a respectful and safe way.

Another object of the present invention is to provide a specific “place” at each conflict resolution location (CRL), a script to follow, and an associated procedure, which together would enable individuals involved in a conflict to “find their voice” and be independent of a third party.

An object of the present invention is to provide an economical system that can be applied in any environment involving people in conflict, and is especially conducive to inner city classroom, work, and home environments.

### SUMMARY OF THE INVENTION

The present invention satisfies these objects by providing a dedicated portable object, taking the form of, for example, a small rug, to be used in each classroom. The rug, called “The Peace Rug” (a service mark of Applicant), is used together with a specialized script according to a set of simple procedural rules. Alternatively, any other portable object defining a small conflict resolution area (CRA) can be substituted for the rug.

The present invention enables conflict resolution among two or more parties by positioning The Peace Rug at a location at which the parties can physically position themselves face-to-face for engaging in a discussion. According to instructions previously provided to the participants, a script is spoken in turn by each of the parties, followed by a set of steps that encourages a continuing engagement dialog, development of a mutually agreeable plan, and promotion of group pride and responsibility for that accomplishment.

The process is intended to enable participants in conflict or dispute, who lack the skills necessary to express their desires and emotions, either at all, or in a courteous, safe manner, to do so in an effective way. The process is directed toward replacing confrontational circumstances with a neutral meeting ground to which a degree of respect is accorded, and where specific rules of conduct apply. The process begins by a first party extending an invitation to at least one second party with whom he or she has a conflict, to join the first party around The Peace Rug. All concerned sit either on, or in proximity, to The Peace Rug, facing each other during the entire process.

The script includes three phrases, each phrase corresponding to the beginning of a respective statement articulating the speaker's perspective. The first phrase, spoken by one party, is directed to one of the other parties who previously took an action that generated a negative feeling or response on the part of the speaker. The first phrase is designed to articulate the action previously taken by the offending party. Specifically, the phrase begins with the phrase “When you . . . ”, after which, the speaker is to describe the offending act or statement. Immediately thereafter, the speaker speaks the second phrase “I felt . . . ”, together with an articulation of the feelings that the negative act or statement caused on the part of the speaker at the time of the act. Lastly, the third phrase “and I need . . . ” is voiced, together with an expression of what altered action the speaker prefers the other party to take in the future, under similar circumstances. These statements are voiced by each of the participants, in turn.

Following the expression by each participant of his or her perspective in connection with the conflict or dispute, a discussion continues until the parties develop and agree to a plan for peaceful engagement in the future. This is accomplished by mutual encouragement of each other to further discuss the conflict and to explore how the two or more parties could attain improved inter-parties relations. Upon acceptance of the plan, preferably, all concerned celebrate the mutually agreeable plan by displaying a symbolic gesture of camaraderie, such as handshaking, a hug, or the like.

### BRIEF DESCRIPTION OF THE DRAWINGS

The above and other features of the present invention and the attendant advantages will be readily apparent to those having ordinary skill in the art and the invention will be more easily understood from the following detailed description of the preferred embodiments of the present invention, taken in conjunction with the accompanying drawings.

FIG. 1 is a pictorial representation of the system of the present invention;

FIG. 2 is a block diagram of instructions to be used in accordance with the method of the present invention.

### DESCRIPTION OF THE PREFERRED EMBODIMENTS

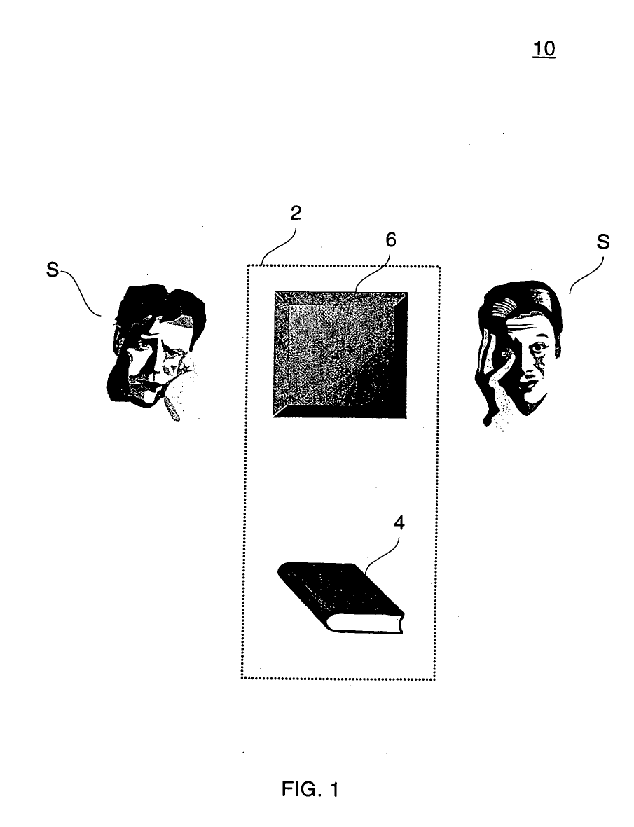

FIG. 1 is a pictorial representation of a preferred embodiment of the system of the present invention, which includes a kit 10 including a set of instructions 4 of the method of the present invention and a portable object 6 to be used in conjunction with the instructions 4. In operation, users of the system of the present invention, typically participants such as students S, are provided with suitable training with regard to instructions 4, and, as the occasion arises, position themselves on, or in close proximity to, portable object 6 and conduct themselves in accordance with instructions 4. Object 6 constitutes a conflict resolution area (CRA) remote or set apart from the customary work or gathering area of the participants and operates as a physical focal point or focal area at which the students S engage each other in a conflict resolution discussion. As a result of prior instruction and a growing familiarity resulting from use, a special identity is associated in the minds of the participants with the conflict resolution process and the CRA of the present invention.

The portable object 6 of the present invention can be any object, and preferably, is a small rug 6, called a “Peace Rug” (service mark of Applicant), which defines the CRA. In a school, home, or office environment, a small rug has the advantages of being inexpensive, lightweight enough to be easily portable, especially by children, and provides a broad, flat shape which, for larger individuals, provides comfortable seating around its periphery, and for small individuals, provides a space on which they can sit together in a face-to-face relationship.

The rug 6 can be made of any desirable material and have any desirable shape and pattern, although, generally, “quiet tones”, such as white, beige or pastel colors are appropriate and supportive of the overall concept embodied by the label “The Peace Rug”. The Peace Rug 6 can be of any size, shape and material suitable for carrying and handling. For example, The Peace Rug can be a relatively soft, pliable, rectangular rug having dimensions of 2 feet by 3 feet for smaller children or individuals, or 4 feet by 6 feet for older children and adults. The important aspect of The Peace Rug is that it defines a specific control area called a “conflict resolution area (CRA) which is identified and associated by individuals at a “conflict resolution location” (CRL) to which individuals may expect to go to resolve their conflicts with others.

Alternatively, object 6 can be any material that can be rolled or folded, such as a plastic or fabric sheet, or it can be an entirely different object taking any desired form, which is used as described herein in connection with The Peace Rug.

Advantageously, but not necessarily, the object 6 can have some connection with the participants, if appropriate. For example, the original Peace Rug concept evolved in a school environment serving a community in which the carpet industry was the principal employer. For purposes of description, the term “The Peace Rug” will be used herein to refer to all portable objects 6 used as described according to the present invention. If the conflict resolution process involved Girl Scouts, a traditional “sit upon” could be utilized to provide an association with the group. For American Indians, or other ethnic groups, an object having some association with that group, as by color, design, or marking, could be used.

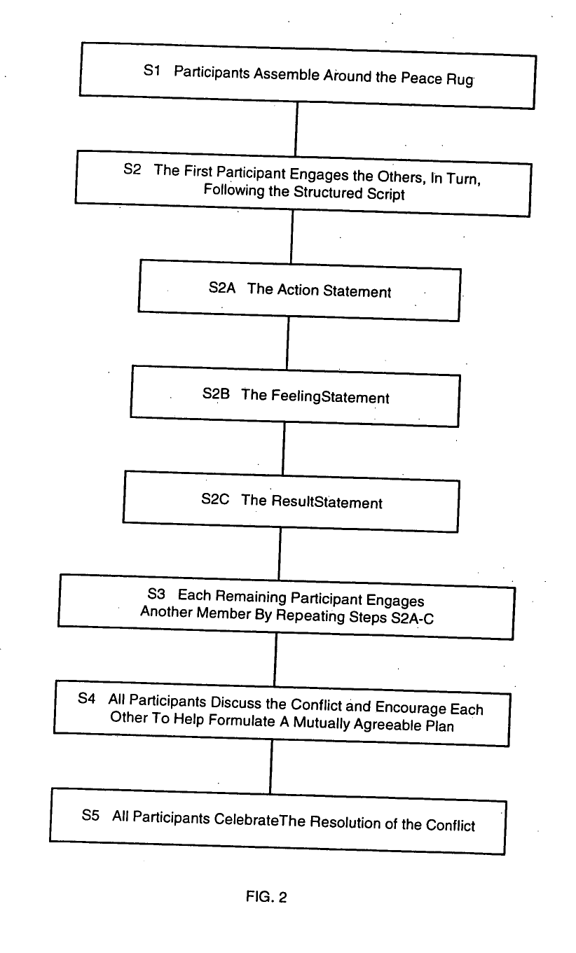

FIG. 2 is a block diagram of steps S1-S5, which are the steps of instructions 4, to be used in accordance with the method of the present invention when a dispute or conflict has occurred, or is about to occur, between a pair, or among a group, of children, adolescents, or adults, hereinafter described for convenience simply as “students”. However, it should and will be recognized that the process is not restricted to students and can be used in the home between family members and in a work environment between employees.

In practice, steps S1-5 are explained to the students so that they become familiar with what is involved and what to expect, either by direct participation or observation, before being called upon to use kit 10 on the occasion of a conflict or dispute. This may be accomplished by demonstrations with a leader acting as a facilitator until the entire process is understood by the participants or students. In short, it is explained that when a conflict arises or is sensed, there is a need to go to The Peace Rug and talk things out in a peaceful and respectful way before it explodes into a violent situation. However, it is also explained that the specific discourse and manner of expression are critical and must be in accordance with the instructions 4. Initiation and continuance of this “talking out” process is facilitated by certain words and phrases together with a set of simple procedural rules according to the present invention. It should also be noted that the process can be initiated after violence has taken place.

The Peace Rug (CRA) may be located in a reserved space (CRL), or it can be stored and unfurled as necessary at the CRL. If more privacy is needed, The Peace Rug can be relocated, but preferably, The Peace Rug should always be placed at a prescribed conflict resolution location. If necessary, to minimize disturbing others, the participants may need to whisper or talk in soft tones. This encourages civility and as such, is a physical exercise in itself that contributes to the overall objective of behavior modification in the face of conflict.

A teacher in a classroom situation benefits from The Peace Rug process because it provides the ability to continue lessons without stopping to referee every conflict or disagreement. The participants are empowered to be able to do peacemaking on his or her own initiative and obtain experience with an engaging, respectful process that encourages civility and self-assurance.

The main principles taught in the use of The Peace Rug are those of being safe, respectful, speaking without interruption, sharing thoughts and feelings without criticism, blaming, complaining, nagging, threatening and/or punishing, as the participants work toward an agreement. While the aforementioned elements of conflict resolution individually may be effective in a given instance, the focal point provided by the physical aspect of gathering around the Peace Rug in face-to-face contact, together with the script and procedural rules in a predefined location, provide an opportunity for the interpersonal skills associated with the aforementioned elements to become integrated for each participant. Obviously, this integration process occurs over time and is influenced by numerous factors, including, but not restricted to, the participant's age, maturity, life experiences, and frequency of involvement with The Peace Rug system. When successful, this process enables victims of conflict to “find their voice”.

In step S1, teachers or leaders can refer students to The Peace Rug or the students can refer themselves with another student, or several students, to The Peace Rug to work out some disagreement. For example, one student involved in a dispute with another student, invites the other student to join him or her at the CRL, requesting the student to sit on, or typically for older students, sit around, The Peace Rug. Alternatively, one student could simply ask to go to The Peace Rug if he or she needed to have a quiet time to be alone and to think if he or she were struggling with some issues in the classroom. It has been found that the process does not work as well, if the leader or teacher is coercive in ordering individuals to The Peace Rug. Where a conflict or violent behavior is evident, a leader may take the initiative and inquire of those having the conflict, “Would you be willing to go to The Peace Rug to talk and to work through these conflicts in order to arrive at some agreement?” or, “Would you please go to The Peace Rug to work out our conflicts?” or, “Could we please talk about our conflicts on The Peace Rug?”

In step S2, after the participating individuals have positioned themselves in proximity to The Peace Rug in a face-to-face relationship, each participant takes a turn in voicing his or her perspective on the conflict by speaking a series of statements, each having a structured beginning provided by steps S2A-C, coupled with text tailored by the speaker to the conflict at hand. Generally, although not necessarily, the individual initiating the conflict resolution session begins the dialog by engaging one of the other participants in a discourse that relates to the conflict from the perspective of the speaker.

In step S2A, the speaker does this by indicating simply and calmly what was done or what was said by the other participant, which is accomplished by framing a statement beginning with the phrase, “When you . . . ”, together with respective additional discourse that relates to the conflict from the perspective of the speaker. This statement is identified as “The Action” statement.

In step S2B, the Action statement is immediately followed by “The Feeling” statement, in which the speaker identifies his or her feelings, such as “sad”, “hurt” or “angry”, as indicative of what the action perpetrated by the other participant aroused in the speaker at the time of the action's occurrence.

In step S2C, the speaker voices “The Request” statement, which identifies what the speaker wants the other participant to do. For example, The Request statement might be “I need you to stop,” “I need you to ask me first,” or “I need you to find a kinder way to say that.”

The intent in using these words is to help establish or give the speaker a “voice”, and yet, enable the speaker to share his or her hurt or feelings in an emotionally safe and non-harmful way. The specific words embodied in the three phrases are set forth herein by example, and serve to identify the action taken by a first party with respect to a second party, the feeling on the part of the second party as a result of the action, and a request in terms of future action on the part of the second party desired by the first party. Any similar dialog intended to identify these concepts is envisioned according to the present invention.

In step S3, another participant in The Peace Rug procedure to whom the Action, Feeling and Result statements were addressed, shares his or her perspective on the conflict at hand, using the same key phrases of steps S2A-C. This continues until all participants have had their chance to speak.

In step S4, a discussion of the conflict and exploration of how those involved could attain an improved relationship are conducted while the parties remain at The Peace Rug. During this discussion the parties encourage each other to participate and contribute in the development of the plan, and, of course, agree with the plan.

As a final step S5, the participates celebrate a new beginning by a ceremonial gesture symbolizing camaraderie that is appropriate to the age and custom of the participants, such as, for example, shaking hands, giving a high five, or a hug.

According the present invention, the participants are instructed about aspects of the procedure that are beneficial, even if events do not proceed as hoped. For example, in the event the alleged offending party to the conflict refuses to participate, there is, at least, the benefit derived from the self satisfying attempt to make peace. The fact that the attempt was made, and the specific words spoken, frequently relieve inner anxieties of speaker and may have an effect on the resistant person at some point in the future. Similarly, even if no resolution is obtained through the structured discussion around The Peace Rug, nevertheless, The Peace Rug itself becomes a place where a participant found his or her “voice”, realizing that he or she did all that could be done to resolve the conflict according to proper principles, providing a sense of satisfaction and general well being. Again, in the absence of an immediate tangible exchange, the participants may be influenced by the process in a way that paves the way for subsequent positive engagement.

The Peace Rug can be applied in venues outside the classroom. It can be adapted in non-class areas, such as playgrounds, and in non-school environments, such as at home or in the work place or in associations and clubs. Thus, participants using The Peace Rug concept can be organizations, each represented by a respective speaker. To this end, the rug may be pre-purchased as a kit 10 in a container 2, shown in FIG. 2 by dashed lines, containing the instructions 4, which includes the script, and rug 6, for convenient portability. In its broader altruistic aspect, The Peace Rug concept is applicable for implementation in schools, homes, neighborhoods, playgrounds, businesses, communities, governments, and nations by peoples of all ages, races, culture, and gender to develop harmony and civility and minimize the problems associated with negative behavior patterns.

### SPECIFIC CASE STUDY EXAMPLE

The Roan School, of Dalton Ga., is located in the northwest corner of the state, and is home of numerous carpet manufacturing facilities. The Roan School is an inner city elementary school, including pre-kindergarten through grade 2, and serves the children of many of the carpet mill workers. The school population numbers over 750 students, most of whom are eligible for free and reduced lunches. Many of these students experience physical and sexual abuse, as well as neglect. A high percentage of the students witness domestic violence on a daily basis. In fact, violence seems to be a hallmark of their existence. Other problems facing these children include little, or no, pre-school experience, language differences due to a large (over 70%) Hispanic population, families without jobs, homelessness, incarcerated parents, single parents, and alcohol and drug abuse in homes.

A staff of over 120 serve these children in 36 classrooms. A school counselor works with each of these classrooms on a rotational basis for instruction and an on-call basis for crisis intervention.

Every fall, a high incidence of conflict is experienced that may be attributed to a number of reasons, including unstructured environment in the summer months, new students who have not learned some of the discipline principles, students acting out from possible abuse or neglect, and students wanting to test the limits of the teachers and the administration. The conflicts found in both the classroom and at recess are overwhelming. Instead of teaching, the teachers find themselves having to referee and settle disputes. For these reasons, there existed a need to teach conflict resolution, communication, and bully-victim violence intervention.

The method of the present invention was presented and demonstrated in each classroom, one classroom at a time. Children were shown how to invite someone to The Peace Rug, what to say at The Peace Rug, and how to reach an agreement before leaving The Peace Rug. During use, at times, the teachers would suggest that the participants in a dispute go to The Peace Rug, and at other times, the students went there on their own.

The results were immediate. There were no more major unresolved conflicts in the classrooms. If, and when, there were disagreements, the teacher asked the students, or the students would request permission, to go to The Peace Rug to solve their problems. Over time, students took the initiative to resolve conflicts without the teacher's intervention. In some instances, the students indicated that The Peace Rug was needed at recess, and in response, an area was designated for that use. Again, conflicts were effectively handled and recess was once again a pleasurable time for both students and teachers.

Students asked the counselor if they could use The Peace Rug idea at home, so that they could work through problems with their siblings. Brothers and sisters began learning to talk through their difficulties in a peaceful and respectful way, and reaching agreements. Moreover, students shared with the counselor that they had asked their parents, who were arguing, to go to The Peace Rug and explained the process to them. In general, peace and civility has taken hold, where, before, violence and abuse were prevalent.

The following example is indicative of the general content and tone of instructions 4, and is not meant to be limiting in terms of the choice of specific exemplary words and phrases, or scope of the present invention:

### The Peace Rug Instructions

Peace and safety are greatly needed in our world, today. However, conflicts in our homes, schools, neighborhoods, businesses, communities, and nations are escalating. The Peace Rug (service mark of Applicant) and the following instructions can provide a safe place and powerful words for conflicts to be resolved. When you can “find your voice” and respectfully share your thoughts and feelings with others with whom you are in conflict, you are taking responsible steps towards greater understanding and agreement. The Peace Rug is meant to provide that physical place for such discussions for both children and adults.

How do I Start?

Explain to your family, school classroom, or place of business that you would like to have a place to solve conflicts as difficulties arise. Explain the instructions below. The Peace Rug is then displayed in an accessible area or can be stored conveniently for use by participants when needed.
When a conflict arises, ask the other person(s) if he or she will come to The Peace Rug when you talk. You may either sit on The Peace Rug, or around the edge.
Explain that you want to share your feelings and thoughts in a special way and that each individual will have a turn without interruption.
   What are the Words to Say when it is Your Turn?
“When you . . . ” [THE ACTION] State simply and calmly what was done or what was said.
“I feel (or felt) . . . ” [THE FEELING] Name the feeling such as sad, hurt, or angry.
“and I need . . . ” [THE REQUEST] Some examples are” “I need you to stop,” “I need you to ask me first,” or “I need you to find a kinder way to say that.”

These words are helpful to give yourself a “voice,” and yet, to share your hurt in an emotionally safe and non-harmful way.
Next, another individual may share, using these same key words.
Then, you ask if you can talk more about the conflict and how things could be better. Keep sharing until you agree upon a plan.
Before The Peace Rug participants “go in peace,” it is important to celebrate a new beginning by shaking hands, giving a high five or a hug, or whatever would be appropriate.
   What if the Other Person Won't Participate?
You cannot control others, but you do have a choice to respectfully express your thoughts and feelings, and to attempt to make peace. If there is no resolution, The Peace Rug becomes the place where you find your voice and did all you could do about the conflict to this point.
If you were able to respectfully share your thoughts and feelings, these words may yet have a powerful effect on the resistant person sometime in the future. Moreover, you can even ask if there is another time when you can meet together at The Peace Rug.

1-19. (canceled)

20. A conflict resolution process for enabling a conflict between at least two parties to be resolved comprising:
selecting a conflict resolution area,
providing said parties with a kit containing a prepared script and set of instructions to be followed in connection with said conflict resolution process and a rolled rug;
opening the kit to remove the script and instructions and said rug, locating the rug at a specific location to thereby define the conflict resolution area and positioning the parties in close proximity to each other for face-to-face contact at said location,
vocalizing by a first of the parties to a second of the parties a set of statements according to the script and the set of instructions; and
vocalizing by the second party a response to said statements of the first party, and continuing the exchange between the first and second parties while at the conflict resolution area until the conflict is resolved.

21. The method set forth in claim 20, further including the step of continuing the exchange between the parties and developing a plan with the agreement of each of the two parties for resolving the conflict.

22. The method set forth in claim 20, further comprising articulating a plan for resolving the conflict and confirming agreement with the articulated plan by a physical gesture.

23. The method set forth in claim 20, wherein the set of statements includes a first statement describing an action taken by the second party which is offensive to the first party, a second statement describing a feeling on the part of the first party as to the effect the action had on the first party at the time the action occurred, and a third statement describing a request on the part of the first party, directed to the second party of an action that should be taken to resolve the conflict.

24. A method of teaching conflict resolution comprising:
assembling at least two participants engaged in a conflict in fact-to-face relationships or a specific location defined by a rug;
requesting a first participant to engage the other participants, in turn, following a structured script;
said structured script including a first action statement;
a second feeling statement; and
a third result statement
each remaining participant engages another participant by repeating to the other participants the structured script,
encouraging all participants to discuss the conflict and encourage each other to formulate a mutually agreeable plan, and
symbolizing the resolution of the conflict by a physical gesture by each of participants.

25. A method as set forth in claim 24 wherein the rug has a dimension of about 2 feet by 3 feet such that all participants face each other while gathered on or around the rug.

26. A teaching method for use in psychological intervention conflicts and resolving interpersonal conflicts among children to address and interrupt negative behavior so that the conflicts among children can be resolved comprising:
defining a conflict resolution area for use as a physical and symbolic focus for convening a cognitive conflict resolution discussion at a specific location in a classroom;
said area being defined by a lightweight and portable rug, movable by a child from a first location to the conflict resolution area
convening the children involved in the mutual interpersonal conflict in face-to-face relationship around the rug at said specific location;
instructing the children to mutually encourage each other to discuss the conflict and reach a resolution of the conflict utilizing instructions for a dialogue to be carried out by the children involved in a conflict resolution discussion at the conflict resolution area said instructions including a first set for a first child seeking resolution of a conflict with a second child including the steps of describing an action which is offensive to the child, describing a feeling on the part of the first child as to the effect the action had on the first child at the time the action occurred, and describing a request on the part of the first child to the second child,
said instructions further including a second set for the second child whose actions were deemed offensive, said second set encouraging a response by the second child showing his or her perspective on the conflict.

27. A teaching method as set forth in claim 26 wherein the first child defines the conflict resolution area by selecting a rolled rug from a storage location and unrolling the rug at a selected location such that the rug defines the conflict resolution area.

28. A teaching method as set forth in claim 26 wherein the rug has a minimum dimension of about 2 feet by 3 feet such that the children involved in the conflict resolution discussion are positioned on or about the rug face-to-face.
